(19) United States
(12) Patent Application Publication
(10) Pub. No.: US 2009/0106168 A1
(43) Pub. Date: Apr. 23, 2009

(54) METHODS AND APPARATUS FOR BUILDING SECURITIZATION POOLS

(75) Inventors: Jonathan Kingsepp, Northfield, IL (US); Jonathan Peterson, Evanston, IL (US)

Correspondence Address: BELL, BOYD & LLOYD, LLP, P.O. Box 1135, CHICAGO, IL, 60690, US

(73) Assignee: NorthBound Solutions, Inc., Northfield, IL (US)

(21) Appl. No.: 11/877,511

(22) Filed: Oct. 23, 2007

(51) Int. Cl. G06Q 40/00; G06Q 10/00

(52) U.S. Cl. 705/36 R; 705/30

(57) ABSTRACT

The present disclosure provides methods and apparatuses for building securitization pools. Using the methods and apparatus herein, users can more easily create securitization pools. Users can set asset properties independent of the way the assets are stored. Additionally, users can create expression definitions that are specific to a given deal. Also, changes to the expressions can be saved for auditing and reporting purposes.

### BACKGROUND

Securitization is a financial process in which interests in loans and other receivables, called assets, are packaged, underwritten, and offered as collateral in exchange for investment. By entering into the securitization transaction, the risk associated with holding a specific set of assets, called a pool, is transferred from the originator of the loans or issuer of the securities, which does not want the risk, to a group of investors, which is willing to take on that risk in exchange for the returns generated by the underlying assets in the pool. Such a transaction is called a deal.

Typically, a securities issuer will select assets to offer investors based on the investors' criteria. The issuer may have one or more Securitization transactions outstanding at a given time. Investors may then select the asset-backed securities that they wish to purchase from the securities issuer.

Currently, securitization systems require an analyst to possess in-depth technical knowledge. Securities issuers maintain detailed information regarding a large number of assets. The asset properties are generally stored as database fields and more involved searches require an analyst to understand complex database structures. The complexity of the asset storage generally results in an analyst passing criteria to a technical specialist, wasting time and causing extra expenses.

Additionally, regulatory statutes require certain information to be captured regarding asset securitization. Currently, some of the required information is captured manually adding to the time and expense of the securitization process and increasing the risk of error.

### SUMMARY

The present disclosure provides methods and apparatuses for building securitization pools. Using the methods and apparatus herein, users can more easily create securitization pools. Users can set asset properties independent of the way the assets are stored. Additionally, users can create expression definitions that are specific to a given deal. Also, changes to the expressions can be saved for auditing purposes.

Additional features and advantages are described herein, and will be apparent from, the following Detailed Description and the figures.

### BRIEF DESCRIPTION OF THE FIGURES

FIG. 1 is a high level block diagram of an example workflow debugging system.

FIG. 2 is a more detailed block diagram showing one example of a client device.

FIG. 3 is a more detailed block diagram showing one example of a server.

FIG. 4 is a screenshot of an example securitization process.

FIG. 5 is a high level block diagram of an example securitization process.

FIG. 6 is a high level block diagram of an example securitization process with a plurality of deals.

### DETAILED DESCRIPTION

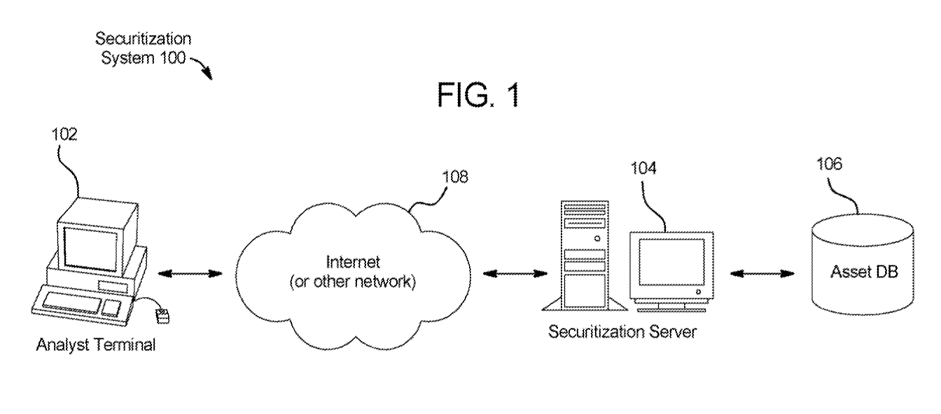

The present system is most readily realized in a network communications system. A high level block diagram of an exemplary network communications system 100 is illustrated in FIG. 1. The illustrated system 100 includes one or more analyst terminals 102, one or more securitization servers 104, and one or more asset databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The securitization server 104 stores a plurality of files, programs, and/or web pages in one or more asset databases 106 for use by the analyst terminals 102. The asset database 106 may be connected directly to the securitization server 104 or via one or more network connections. The asset database 106 preferably stores asset data.

One securitization server 104 may interact with a large number of analyst terminals 102. Accordingly, each securitization server 104 is typically a high end computer with a large storage capacity, one or more fast microprocessors, and one or more high speed network connections. Conversely, relative to a typical securitization server 104, each analyst terminal 102 typically includes less storage capacity, a single microprocessor, and a single network connection.

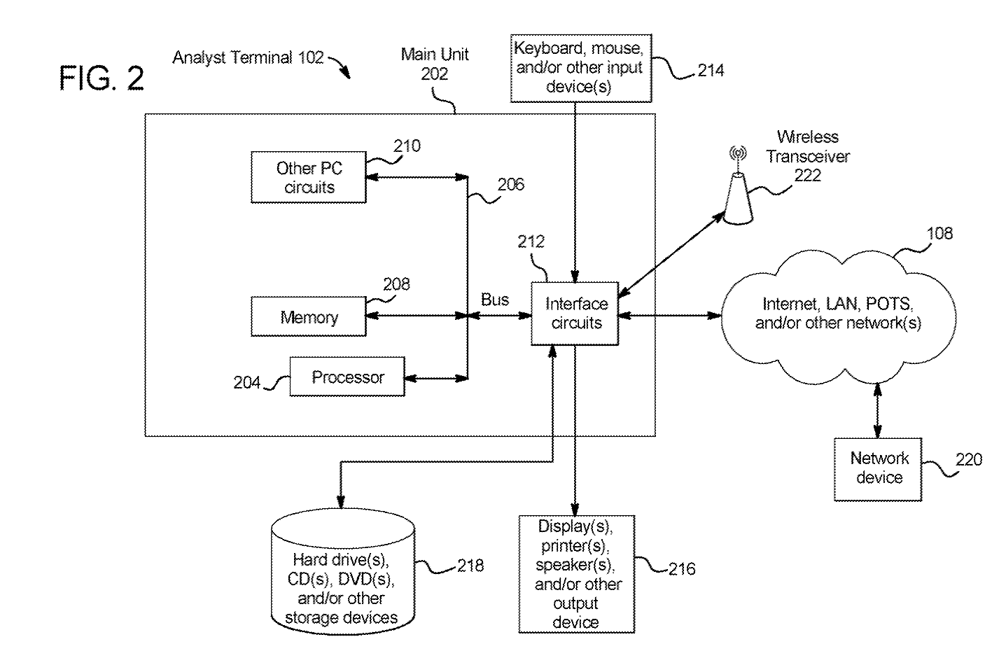

A more detailed block diagram of a analyst terminal 102 is illustrated in FIG. 2. The analyst terminal 102 may include a personal computer (PC), a personal digital assistant (PDA), an Internet appliance, a cellular telephone, or any other suitable communication device. The analyst terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIURM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the analyst terminal 102. For example, the display 216 may be used to display web pages received from the securitization server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the analyst terminal 102.

The analyst terminal 102 may also exchange data with other network devices 220 via a connection to the network 108. The network connection may be any type of network connection, such as an Ethernet connection, digital subscriber line (DSL), telephone line, coaxial cable, etc. Users of a analyst terminal 102 may be required to register with the securitization server 104. In such an instance, each user of a analyst terminal 102, may choose a user identifier (e.g., e-mail address) and a password which may be required for the activation of services. The user identifier and password may be passed across the network 108 using encryption built into the analyst terminal 102 browser. Alternatively, the user identifier and/or password may be assigned by the securitization server 104.

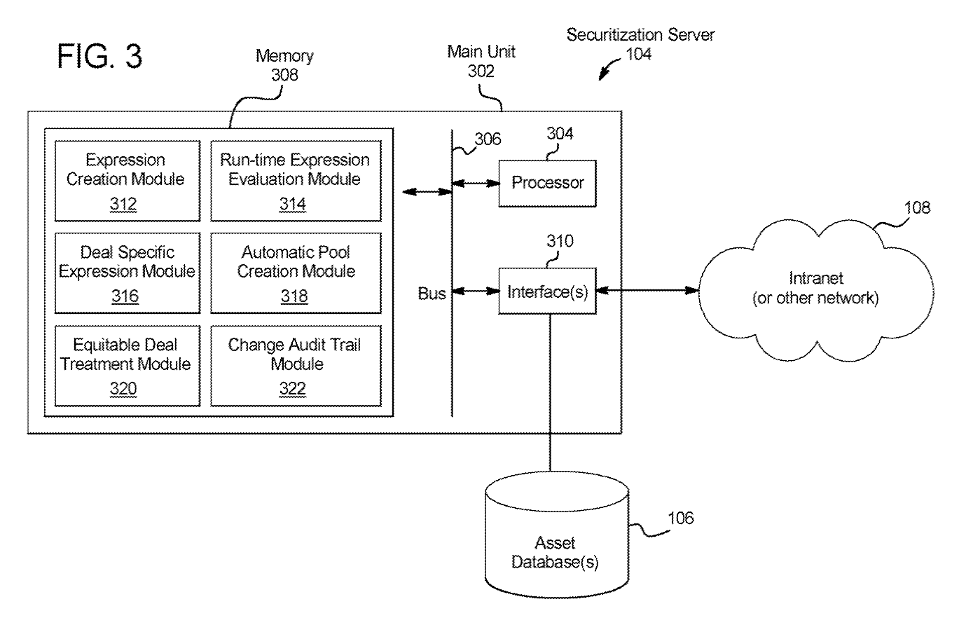

A more detailed block diagram of a securitization server 104 is illustrated in FIG. 3. Like the analyst terminal 102, the main unit 302 in the securitization server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

In particular, the memory 308 preferably stores an Expression Creation Module 312, a Run-Time Expression Evaluation Module 314, a Deal Specific Expression Module 316, an Automatic Pool Creation Module 318, an Equitable Deal Treatment Module 320 and a Change Audit Trail Module 322.

The Expression Creation Module 312 may allow an Analyst at an Analyst Terminal 102 to create expressions for assets. The Analyst may create an expression that performs a calculation on pre-existing asset properties and the expression may create a new property for an asset. For example, the expression may take an asset's “Driver Credit Rating” and “Balance” and create a new property “Risk-Adjusted Balance” equal to the “Driver Credit Rating” divided by a value such as 800 and multiplied by the “Balance.” The expression may be stored in the Asset Database 106, or another suitable storage device, associated with a corresponding asset.

The Run-Time Expression Evaluation Module 314 may evaluate the expressions at run-time. For example, at run-time the expression may call for retrieving external data such as an interest rate, the module 314 may cause the securitization server 104 to retrieve the information from a connected server, through the internet or other network 108, etc. This allows for expressions that include external and up-to-date information.

The Deal Specific Expression Module 316 may store the expressions for assets based on deals. An Analyst may wish to use different data sources for expressions based on what a deal requires, and therefore the deal specific expression module 316 may store in the Asset Database 106, or another suitable storage device, data associating deals with expression definitions. For example, the “securitized value” of an asset may be defined as the “Balance” of an asset for Deal 1 and defined as “Risk Adjusted Balance” for Deal 2.

The Automatic Pool Creation Module 318 may automatically create pools of assets based on criteria defined by the Analyst at run-time. The Automatic Pool Creation Module 318 may use artificial intelligence to determine which assets to include in a pool. The system may create a large number of pools based on a great number of criteria. The Automatic Pool Creation Module 318 may use the expressions stored in the Asset Database 106, or another suitable storage device, when creating the pools.

The Equitable Deal Treatment Module 320 may ensure that multiple deals run simultaneously will be treated fairly. For example, when multiple deals are run there is a risk that certain deals will be fulfilled before others. The Equitable Deal Treatment Module 320 may ensure that one deal is not favored over others and that each deal is treated fairly. For example, the Equitable Deal Treatment Module 320 may make multiple passes over the deals to ensure fairness and to maximize the value of assets that are included across all deals.

The Change Audit Trail Module 322 may store a history of changes made to expressions for auditing purposes. For example, when an Analyst creates or changes an existing expression, the Change Audit Trail Module 322 may store the changes to the expressions in the Asset Database 106 or another suitable storage device. The Change Audit Trail Module 322 may also store the changes in the actual values of the evaluated expressions for auditing purposes in the Asset Database 106 or another suitable storage device.

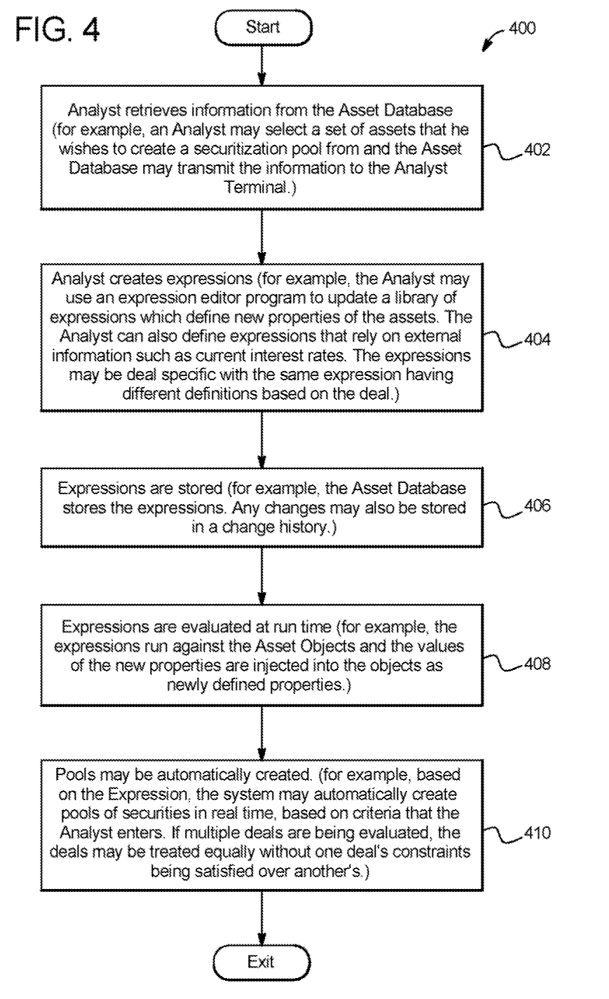

A flowchart of an example process 400 for building securitization pools is illustrated in FIG. 4. Although the process 400 is described with reference to the flowchart illustrated in FIG. 4, it will be appreciated that many other methods of performing the acts associated with process 400 may be used. For example, the order of many of the acts may be changed, and some of the acts described may be optional. In addition, it will be appreciated that this entire process may be repeated on a frequent-and-recurring basis, typically daily, weekly or monthly. For instance, the analyst may create a new pool of assets each month, such that all assets in a deal will be represented by a number of pools. This recurring process ensures that the issuer maximizes its investment in the securitization deal and helps ensure ongoing compliance with the terms, conditions and stipulations of the deal.

In this example, the Analyst retrieves information from the Asset Database 106 in block 402. For example, an Analyst may select a set of assets that he wishes to create a securitization pool from and the Asset Database 106 may transmit the information to the Analyst Terminal 102.

In block 404, the Analyst creates expressions. For example, the Analyst may use an expression editor program to create or update a library of expressions which define new properties of the assets. The expressions may be based on existing properties, outside data or a combination of both. For example, the expressions may take an asset's “Driver Credit Rating” and “Balance” and create a new property “Risk-Adjusted Balance” equal to the “Driver Credit Rating” divided by a value such as 800 and multiplied by the “Balance.” In another example, the expression may use an outside data source such as an interest rate.

In block 406, the expressions are stored. For example, the Deal Specific Expression Module 316 stores the deal-specific expressions in the Asset Database 106. The Change Audit Trail Module 322 may store all changes and additions of expressions. For example, the Change Audit Trail Module 322 may store a change history in the Asset Database 106. Additionally, changed property values may also be stored in the Asset Database 106.

In block 408, the expressions are evaluated at run-time. For example, expressions may be run against asset objects and the values of the new properties may be injected into the objects as newly defined properties.

In block 410 pools consisting of a subset of the assets retrieved from the database in block 402 may be automatically created. For example, the Automatic Pool Creation Module 318 may create pools of assets in real-time, using the values of the expressions evaluated in block 408, such that the deal's criteria as entered by the Analyst are met. If multiple deals are being evaluated, the Equitable Deal Treatment Module 320 may ensure that the deals are being treated fairly. For example, the Equitable Deal Treatment module 320 may run multiple passes over the deals to ensure that one deal's criteria are not met before other deals.

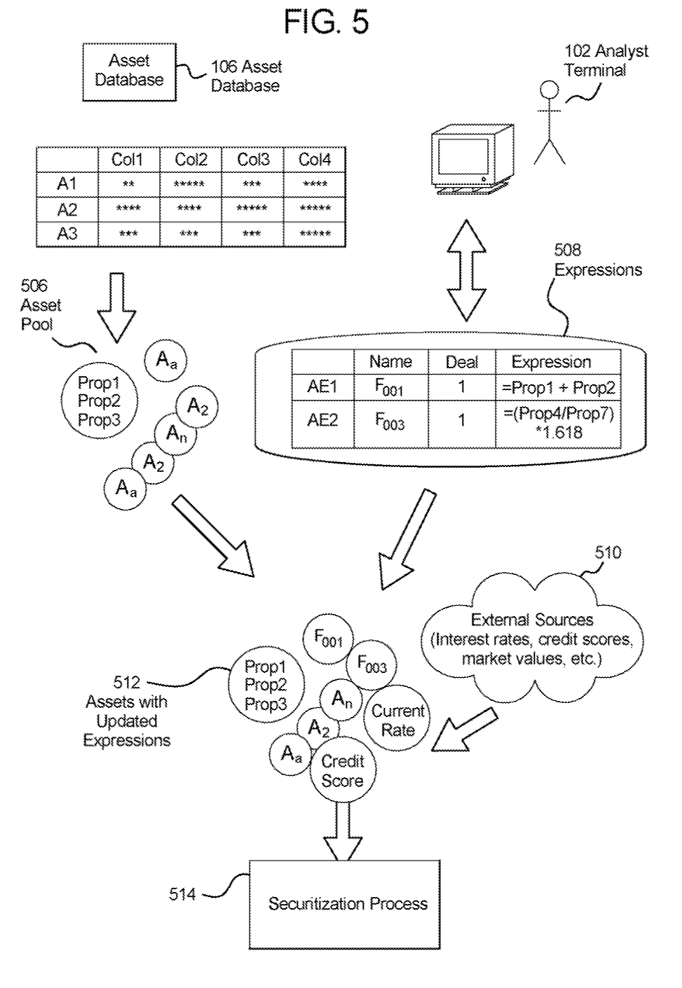

A high level block diagram of an example securitization process is illustrated in FIG. 5. The process may have an asset database 106 and an analyst terminal 102. The analyst may create expressions 508 and use the expressions as criteria in creating the initial pool of assets 506 from which to select in the securitization process 514. For example, based on certain properties the analyst at the analyst terminal 102 may select an initial pool of assets.

The analyst at the analyst terminal 102 may create expressions 508 and use the expressions to inject new properties into the assets 506. For example, the analyst may use an expression editor to create expressions based on an asset's existing properties or external information 510 as is described in relation to block 404. The external information 510 may be incorporated at run time to obtain values for the expressions. The assets with the updated expressions 512 may then be utilized in the securitization process 514.

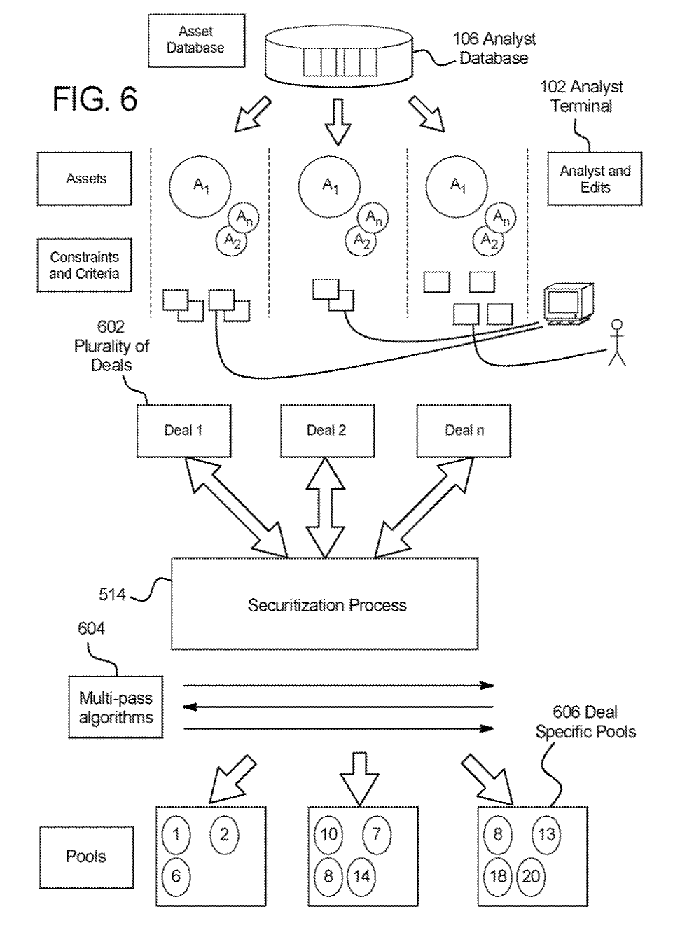

A high level block diagram of an example securitization process with a plurality of deals is illustrated in FIG. 6. The process may have an asset database 106, an analyst terminal 102, expressions 508 and an asset pool 506.

An analyst at an analyst terminal 102 may specify details for a number of deals to create a plurality of deals 602. For example, an expression may be deal specific or may apply to all deals. A criterion may also be deal specific or apply to all deals. Criteria may be based on the properties and expressions of an asset. For example, a criterion may return all assets where the driver's credit rating is above 700. A deal may include a plurality of criteria.

The plurality of deals 602 may then be sent to the securitization process 514 to create deal specific pools 606. For example, the process may perform multiple passes 604 over the plurality of deals 602, distributing the available assets among the deals so as to maximize the value of the assets assigned to each deal, and employing the Equitable Deal Treatment Module 320 to ensure that each deal is treated equitably. Further, this process may be repeated on a periodic basis over time, such that the process of selecting assets for a pool will be repeated daily, weekly or monthly.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for building a securitization pool, the method comprising:
selecting data indicative of a first group of financial assets, each financial asset having a first property indicative of a value associated with the financial asset;
creating an expression associated with at least one of the financial assets, the expression being based on the first property;
evaluating the expression with a calculating device by calculating a value of the expression;
storing the value of the expression and associating the value of the expression with data indicative of the at least one financial asset as a second property;
receiving data indicative of a deal, the deal including a criterion wherein the criterion includes a threshold value associated with at least one of the first property and the second property; and
creating data indicative of a securitization pool, wherein the securitization pool is a second group of financial assets where the second group of financial assets is a subset of the first group of financial assets and where the second group of financial assets satisfy the criterion of the deal.

2. The method of claim 1, including storing a changed expression log, wherein the changed expression log includes changes to the expression and to the value of the expression.

3. The method of claim 1, wherein storing the expression includes storing data indicative of a deal value associated with the expression and the deal.

4. The method of claim 1, wherein creating a securitization pool includes performing a plurality of evaluations on the first group of assets in order to ensure equitable treatment of a plurality of deals.

5. The method of claim 1, wherein the expression is additionally based on an external value.

6. The method of claim 5, including retrieving the external value associated with the expression.

7. The method of claim 1, including storing a changed asset value log, the changed asset value log including a changed value associated with the at least one financial asset and the deal.

8. A system for building a securitization pool, the system comprising:
(i) receive a selection indicative of a first group of financial assets, each of the financial assets having a first property indicative of a value associated with the financial asset;
(ii) receive an expression associated with at least one of the financial assets, the expression based on the first property;
(iii) evaluate the expression by calculating a value of the expression;
(iv) store the value of the expression and associate the value of the expression with data indicative of the at least one financial asset as a second property;
(v) receive data indicative of a deal, the deal including a criterion wherein the criterion includes a threshold value associated with at least one of the first property and the second property; and
(vi) create and transmit data indicative of a securitization pool, wherein the securitization pool is a second group of financial assets where the second group of financial assets is a subset of the first group of financial assets and where the second group of financial assets satisfy the criterion of the deal.

9. The system of claim 8, wherein the server is configured to store a changed expression log, wherein the changed expression log includes changes to the expression and to the value of the expression.

10. The system of claim 8, wherein the server is configured to store data indicative of a deal value associated with the expression and the deal.

11. The system of claim 8, wherein the server is configured to perform a plurality of evaluations on the first group of assets in order to ensure equitable treatment of a plurality of deals.

12. The system of claim 8, wherein the expression is additionally based on an external value.

13. The system of claim 12, wherein the server is configured to retrieve the external value associated with the expression.

14. The method of claim 8, wherein the server is configured to store a changed asset value log, the changed asset value log including a changed value associated with the at least one financial asset and the deal.

15. At least one computer readable medium storing instructions to cause at least one computing device to:
receive a selection indicative of a first group of financial assets, each of the financial assets having a first property indicative of a value associated with the financial asset;
receive an expression associated with at least one of the financial assets, the expression based on the first property;
evaluate the expression by calculating a value of the expression;
store the value of the expression and associate the value of the expression with data indicative of the at least one financial asset as a second property;
receive data indicative of a deal, the deal including a criterion wherein the criterion includes a threshold value associated with at least one of the first property and the second property; and
create and transmit data indicative of a securitization pool, wherein the securitization pool is a second group of financial assets where the second group of financial assets is a subset of the first group of financial assets and where the second group of financial assets satisfy the criterion of the deal.

16. The computer readable medium of claim 15, wherein the instructions are configured to cause at least one computing device to store a changed expression log, wherein the changed expression log includes changes to the expression and to the value of the expression.

17. The computer readable medium of claim 15, wherein the instructions are configured to cause at least one computing device to store data indicative of a deal value associated with the expression and the deal.

18. The computer readable medium of claim 15, wherein the instructions are configured to cause at least one computing device to perform a plurality of evaluations on the first group of assets in order to ensure equitable treatment of a plurality of deals.

19. The computer readable medium of claim 15, wherein the expression is additionally based on an external value.

20. The computer readable medium of claim 19, wherein the instructions are configured to cause at least one computing device to retrieve the external value associated with the expression.

21. The computer readable medium of claim 15, wherein the instructions are configured to cause at least one computing device to store a changed asset value log, the changed asset value log including a changed value associated with the at least one financial asset and the deal.
